(19) United States
(12) Patent Application Publication
(10) Pub. No.: US 2011/0235554 A1
(43) Pub. Date: Sep. 29, 2011

(54) COMMUNICATION METHOD, RELAY STATION, AND COMMUNICATION SYSTEM

(75) Inventor: Xiaofeng CHEN, Shenzhen (CN)

(73) Assignee: HUAWEI TECHNOLOGIES CO., LTD., Shenzhen (CN)

(21) Appl. No.: 13/153,686

(22) Filed: Jun. 6, 2011

Related U.S. Application Data
(63) Continuation of application No. PCT/CN2009/075302, filed on Dec. 4, 2009.

(30) Foreign Application Priority Data
Dec. 8, 2008 (CN) 200810239100.4
Jan. 23, 2009 (CN) 200910003792.7

(51) Int. Cl. H04B 7/14

(52) U.S. Cl. 370/279; 370/315

(57) ABSTRACT

A communication method, a relay station, and a communication system are provided. The method includes: communicating with a base station by adopting a first frame resource in a first frame structure; and communicating with a terminal served by the relay station by adopting a second frame resource in a second frame structure different from the first frame structure. Therefore, the base station and the relay station adopt different frame structures, so a problem that a Hybrid Automatic Repeat Request (HARQ) process is affected greatly by using the same frame structure is avoided, thereby improving the performance and a utilization rate of resources.

### CROSS-REFERENCE TO RELATED APPLICATIONS

This application is a continuation of International Application No. PCT/CN2009/075302, filed on Dec. 4, 2009, which claims priority to Chinese Patent Application No. 200810239100.4, filed on Dec. 8, 2008 and Chinese Patent Application No. 200910003792.7, filed on Jan. 23, 2009, all of which are hereby incorporated by reference in their entireties.

### FIELD OF THE INVENTION

The present invention relates to mobile technologies, and in particular, to a communication method, a relay station, and a communication system.

### BACKGROUND OF THE INVENTION

The relay technology can provide wider coverage area for user and very high data throughput, so it is widely applied in the mobile communication technology. In a Time Division Duplex (TDD) system that adopts the relay technology, a relay backhaul link and a relay access link adopt the same link, and if a relay station performs reception and transmission at the same time, self-interference occurs. The relay backhaul link is a link between a base station and the relay station, and the relay access link is a link between the relay station and a terminal served by the relay station (the following terminal is the terminal served by the relay station unless otherwise specified). In order to avoid the self-interference, a basic solution is that the relay station is unable to perform reception and transmission at the same time. For example, in a Long Term Evolution (LTE) system or an LTE Advanced (LTE-A) system, one method may be that a blank subframe is defined in a radio frame structure configured in the relay station, the base station communicates with the relay station at the blank subframe, the relay station communicates with the terminal at a subframe other than the blank subframe, and at the blank subframe, only the communication between the base station and the relay station occurs. Another method may be that a Multicast Broadcast Single Frequency Network (MBSFN) subframe is defined in a radio frame structure configured in the relay station. The MBSFN subframe includes control part and data part which are separated in time, such as a unicast and a physical multicast channel transmission part; at the MBSFN subframe, the base station communicates with the relay station at the data part of the MBSFN, and the relay station communicates with the terminal at the control part of the MBSFN.

According to the technical solution provided by the prior art, when relay transmission is performed, many processes affecting a Hybrid Automatic Repeat Request (HARQ) feedback exist, and the performance is poor.

### SUMMARY OF THE INVENTION

The present invention is directed to a communication method, a relay station, and a communication system, so as to solve problems of many affected processes and poor performance.

An embodiment of the present invention provides a communication method, where the method includes:

communicating with a base station by adopting a first frame resource in a first frame structure; and communicating with a terminal served by the relay station by adopting a second frame resource, where the second frame resource is included in a second frame structure different from the first frame structure.

An embodiment of the present invention provides a relay station, where the relay station includes: a first communication module, configured to communicate with a base station by adopting a first frame resource in a first frame structure; and a second communication module, configured to communicate with a terminal served by the relay station by using a second frame resource, where the second frame resource is included in a second frame structure different from the first frame structure.

An embodiment of the present invention further provides a communication system, where the communication system includes: a relay station, configured to communicate with a base station by adopting a first frame resource in a first frame structure, and communicate with a terminal served by the relay station by using a second frame resource, where the second frame resource is included in a second frame structure different from the first frame structure.

According to embodiments of the present invention, the base station and the relay station respectively adopt different frame structures, so that a collision for selecting subframe may be avoided, resources is fully used, thereby affecting less HARQ processes, and improving the performance.

### BRIEF DESCRIPTION OF THE DRAWINGS

FIG. 1 is a schematic flow chart of a communication method according to an embodiment of the present invention;

FIG. 2 is a schematic structural view of a frame configuration according to an embodiment of the present invention;

FIG. 3 is a schematic structural view of an equivalent frame configuration according to an embodiment of the present invention;

FIG. 4 is a schematic structural view of another frame configuration according to an embodiment of the present invention;

FIG. 5 is a schematic structural view of another frame configuration according to an embodiment of the present invention;

FIG. 6 is a schematic structural view of another frame configuration according to an embodiment of the present invention;

FIG. 7 is a schematic structural view of another frame configuration according to an embodiment of the present invention;

FIG. 8 is a schematic structural view of another frame configuration according to an embodiment of the present invention;

FIG. 9 is a schematic structural view of another frame configuration according to an embodiment of the present invention;

FIG. 10 is a schematic structural view of another frame configuration according to an embodiment of the present invention;

FIG. 11 is a schematic structural view of another frame configuration according to an embodiment of the present invention;

FIG. 12 is a schematic structural view of another frame configuration according to an embodiment of the present invention;

FIG. 13 is a schematic structural view of another frame configuration according to an embodiment of the present invention;

FIG. 14 is a schematic structural view of another frame configuration according to an embodiment of the present invention;

FIG. 15 is a schematic structural view of a relay station according to an embodiment of the present invention; and

FIG. 16 is a schematic structural view of a communication system according to an embodiment of the present invention.

### DETAILED DESCRIPTION OF THE EMBODIMENTS

Technical solutions of the present invention are further described in detail with reference to the accompanying drawings and embodiments in the following.

The solutions provided by the embodiments of the present invention may be applied in systems such as an LTE, an LTE-A, a World Interoperability for Microwave Access (WiMax), and an Ultra-Wideband (UMB). In order to better understand the present invention, an LTE TDD system is taken as an example to briefly describe some basic concepts in the following.

In the LTE TDD system, one radio frame includes ten subframes, one radio frame is 10 ms in length, and each subframe is 1 ms in length. Currently, the radio frame of the LTE TDD system includes seven frame structures, and in each frame structure, main elements include an uplink-downlink configuration, an HARQ feedback timing, and a scheduling relationship. The uplink-downlink configuration may be seen in Table 1.

TABLE 1

| Serial Number | Switch | | | | | | | | | | |
|---|---|---|---|---|---|---|---|---|---|---|---|
| of Frame | Period- | Serial Number of Subframe | | | | | | | | | |
| Structure | icity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

D indicates that the subframe is applicable to downlink (a downlink subframe), U indicates that the subframe is applicable to uplink (an uplink subframe), and S indicates that the subframe is a special subframe. The special subframe includes three parts, namely, DwPTS, Gp, and UpPTS, where DwPTS occupies longer time and is used for transmitting downlink information, Gp is used for guard period for a switch of uplink and downlink, and UpPTS is used for transmitting uplink information.

A frame structure having a serial number of 0 to 6 is respectively called a zero^{th} configuration, a first configuration, a second configuration, a third configuration, a fourth configuration, a fifth configuration, and a sixth configuration; and a subframe having a serial number of 0 to 9 is respectively called a zero^{th} subframe, a first subframe, a second subframe, a third subframe, a fourth subframe, a fifth subframe, a sixth subframe, a seventh subframe, an eighth subframe, and a ninth subframe.

In order to ensure that a base station or a relay station may successfully receive information sent by a User Equipment (UE), the UE sends a Physical Uplink Shared Channel (PUSCH) on an uplink subframe having a serial number of n, and receives an Acknowledgement/Negative Acknowledgement (ACK/NAK) on a Physical HARQ Indication Channel (PHICH) on a downlink subframe having a serial number of n+k. The configuration of positions of the PHICH may be seen in Table 2.

TABLE 2

| Serial Number | | | | | | | | | | |
|---|---|---|---|---|---|---|---|---|---|---|
| of Frame | Serial Number of Subframe | | | | | | | | | |
| Structure | 0 | 1 | 2 | 3 | 4 | 5 | 6 | 7 | 8 | 9 |
| 0 | | | 4 | 7 | 6 | | | 4 | 7 | 6 |
| 1 | | | 4 | 6 | | | | 4 | 6 | |
| 2 | | | 6 | | | | | 6 | | |
| 3 | | | 6 | 6 | 6 | | | | | |
| 4 | | | 6 | 6 | | | | | | |
| 5 | | | 6 | | | | | | | |
| 6 | | | 4 | 6 | 6 | | | 4 | 7 | |

The numerals in the table indicate required time intervals for obtaining the position of the PHICH, that is, values of the k. For example, as for a frame structure having a configuration serial number of 0, the numeral k in a subframe having a serial number of n being 2 (it may be known from Table 1 that the subframe is an uplink subframe) is 4, which shows that a subframe having a serial number of n+k, that is, a subframe of 2+4 (it may be known from Table 1 that the subframe having a serial number of 6 is a downlink subframe) is used to transmit the PHICH corresponding to the subframe having a serial number of 2. The remaining has the same principle.

In order to ensure that the UE can successfully receive the information sent by the base station or the relay station, the UE receives a Physical Downlink Shared Channel (PDSCH) on the downlink subframe having a serial number of n, and sends the ACK/NAK on the uplink subframe having a serial number of n+k. The configuration of the ACK/NAK positions may be seen in Table 3.

TABLE 3

| Serial Number | | | | | | | | | | |
|---|---|---|---|---|---|---|---|---|---|---|
| of Frame | Serial Number of Subframe | | | | | | | | | |
| Structure | 0 | 1 | 2 | 3 | 4 | 5 | 6 | 7 | 8 | 9 |
| 0 | 4 | 6 | | | | 4 | 6 | | | |
| 1 | 7 | 6 | | | 4 | 7 | 6 | | | 4 |
| 2 | 7 | 6 | | 4 | 8 | 7 | 6 | | 4 | 8 |
| 3 | 4 | 11 | | | | 7 | 6 | 6 | 5 | 5 |
| 4 | 12 | 11 | | | 8 | 7 | 7 | 6 | 5 | 4 |
| 5 | 12 | 11 | | 9 | 8 | 7 | 6 | 5 | 4 | 13 |
| 6 | 7 | 7 | | | | 7 | 7 | | | 5 |

The numerals in the table indicate required time intervals for obtaining the ACK/NAK positions, that is, the values of the k. For example, as for a frame structure having a configuration serial number of 0, the numeral k in the subframe having a serial number of n being 0 (it may be known from Table 1 that the subframe is a downlink subframe) is 4, which shows that a subframe having a serial number of n+k, that is, a subframe of 0+4 (it may be known from Table 1 that the subframe having a serial number of 4 is an uplink subframe) is used to transmit the ACK/NAK corresponding to the subframe having a serial number of 0. The remaining has the same principle.

In order to ensure that the UE is successfully scheduled by the base station or the relay station, the UE receives information of an uplink scheduling relationship on a downlink subframe having a serial number of n, and if k is used to indicate a scheduling relationship, the UE sends the PUSCH on an uplink subframe having a serial number of n+k. The scheduling relationship for uplink transmission in each configuration ratio may be seen in Table 4.

TABLE 4

| | Uplink-downlink | | | | | | | | | | |
|---|---|---|---|---|---|---|---|---|---|---|---|
| Serial Number | Configuration | | | | | | | | | | |
| of Frame | Ratio/Scheduling | Serial Number of Subframe | | | | | | | | | |
| Structure | relationship | 0 | 1 | 2 | 3 | 4 | 5 | 6 | 7 | 8 | 9 |
| 0 | 1:3 | D | S | U | U | U | D | S | U | U | U |
| | Scheduling | G0-4 | G1-6 | | | | G5-4 | G6-6 | | | |
| | relationship | G0-7 | G1-7 | | | | G5-7 | G6-7 | | | |
| 1 | 2:2 | D | S | U | U | D | D | S | U | U | D |
| | Scheduling | | G1-6 | | | G4-4 | | G6-6 | | | G9-4 |
| | relationship | | | | | | | | | | |
| 2 | 3:1 | D | S | U | D | D | D | S | U | D | D |
| | Scheduling | | | | G3-4 | | | | | G8-4 | |
| | relationship | | | | | | | | | | |
| 3 | 6:3 | D | S | U | U | U | D | D | D | D | D |
| | Scheduling | G0-4 | | | | | | | | G8-4 | G9-4 |
| | relationship | | | | | | | | | | |
| 4 | 7:2 | D | S | U | U | D | D | D | D | D | D |
| | Scheduling | | | | | | | | | G8-4 | G9-4 |
| | relationship | | | | | | | | | | |
| 5 | 8:1 | D | S | U | D | D | D | D | D | D | D |
| | Scheduling | | | | | | | | | G8-4 | |
| | relationship | | | | | | | | | | |
| 6 | 3:5 | D | S | U | U | U | D | S | U | U | D |
| | Scheduling | G0-7 | G1-7 | | | | G5-7 | G6-7 | | | G9-5 |
| | relationship | | | | | | | | | | |

In the table, Gn-k indicates that scheduling relationship information is received at the subframe having the serial number of n, and the PUSCH is sent at the subframe having the serial number of n+k. For example, as for a frame structure having a configuration serial number of 0, the numeral G0-4 in the subframe having a serial number of n being 0 (it may be known from Table 4 that the subframe is a downlink subframe) shows that the subframe having the serial number of n+k, that is, the subframe of 0+4 (it may be known from Table 4 that the subframe having a serial number of 4 is an uplink subframe) transmits the PUSCH, so as to implement scheduling of the base station for the UE. The remaining has the same principle.

To sum up, the uplink-downlink configuration, the feedback timing, and the scheduling relationship for currently different frame structures are as shown in Table 5.

TABLE 5

| Serial Number | | | | | | | | | | |
|---|---|---|---|---|---|---|---|---|---|---|
| of Frame | Serial Number of Subframe | | | | | | | | | |
| Structure | 0 | 1 | 2 | 3 | 4 | 5 | 6 | 7 | 8 | 9 |
| 0 | D4 | S7 | U6 | U0 | U0 | D9 | S2 | U1 | U5 | U5 |
| | G7 | G7 | | | | G9 | G2 | | | |
| | G7 | G8 | | | | G2 | G3 | | | |
| 1 | D7 | S7 | U6 | U9 | D8 | D2 | S2 | U1 | U4 | D3 |
| | | G7 | | | G8 | | G2 | | | G3 |
| 2 | D7 | S7 | U8 | D7 | D2 | D2 | S2 | U3 | D2 | D7 |
| | | | | G7 | | | | | G2 | |
| 3 | D4 | S2 | U8 | U9 | U0 | D2 | D2 | D3 | D3 | D4 |
| | G4 | | | | | | | | G2 | G3 |
| 4 | D2 | S2 | U8 | U9 | D2 | D2 | D3 | D3 | D3 | D3 |
| | | | | | | | | | G2 | G3 |
| 5 | D2 | S2 | U8 | D2 | D2 | D2 | D2 | D2 | D2 | D2 |
| | | | | | | | | | G2 | |
| 6 | D7 | S8 | U6 | U9 | U0 | D2 | S3 | U1 | U5 | D4 |
| | G7 | G8 | | | | G2 | G3 | | | G4 |

D indicates the downlink, U indicates the uplink, the numeral after D or U indicates a feedback frame of the frame of D or U, and the numeral after G indicates a subframe scheduled by the frame of G For example, in a frame structure having a serial number of 1 (a first configuration), S7G7 under a subframe having a serial number of 1 (a first subframe) means that the first subframe needs to be fed back by a seventh subframe (a subframe having a serial number of 7), that is, the seventh subframe is a feedback subframe of the first subframe, and the first subframe schedules the seventh subframe at the same time. The remaining has the same principle. The following embodiments may be analyzed on the basis of Table 5.

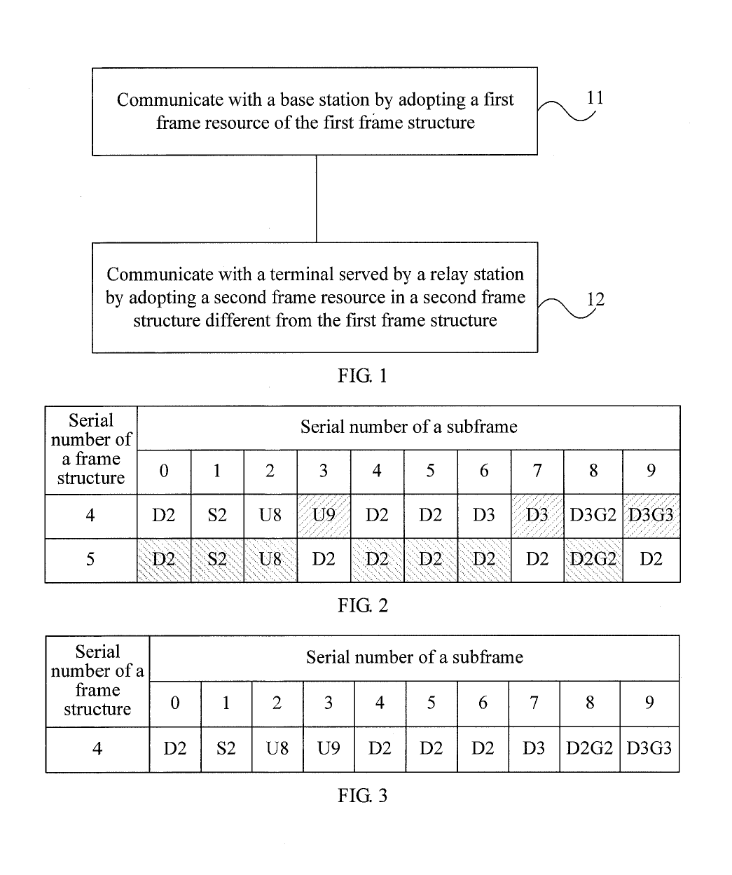

FIG. 1 is a schematic flow chart of a communication method according to an embodiment of the present invention, and the method includes the following steps.

Step 11: Communicate with a base station by adopting a first frame resource in a first frame structure.

Step 12: Communicate with a terminal served by a relay station by adopting a second frame resource in a second frame structure different from the first frame structure.

In the prior art, if the base station and the relay station adopt the same frame structure, a subframe collision is likely to occur, thereby affecting HARQ processes, and wasting resources. For example, the frame structure adopted by the base station and the relay station includes a first frame resource used for communication between the base station and the relay station, a certain subframe other than the first frame resource exists, and a feedback subframe corresponding to the certain subframe is located in the first frame resource. It is indicated from the above description that the certain subframe is used for communication between the relay station and the terminal, and the feedback subframe corresponding to the certain subframe is used for communication between the base station and the relay station. As the base station and the relay station adopt the same frame structure, the collision problem cannot be solved. In the embodiments of the present invention, as the base station and the relay station adopt different frame structures, the terminal may avoid the subframe collision, resources are fully used, normal HARQ processes between the relay station and the terminal are ensured, and the performance is improved.

The above process will be described from two sides of the base station and the relay station below, and includes the following.

A: The base station adopts a first frame structure, the relay station adopts a second frame structure, and the first frame structure is different from the second frame structure. The first frame structure and the second frame structure may be selected in all frame structures of a TDD system.

B: The base station selects some subframes in the adopted first frame structure to be a first frame resource, and the base station communicates with the relay station at the first frame resource. A zero^{th} subframe, a first subframe, a fifth subframe, and a sixth subframe are used for performance control over the terminal, therefore, the first frame resource cannot include any one of the four subframes. For example, if the first frame structure is a fourth configuration, and the first frame resource includes a third subframe, a seventh subframe, and a ninth subframe, the base station communicates with the relay station at the third subframe, the seventh subframe, and the ninth subframe.

C: The relay station selects a second frame resource in the adopted second frame structure, and the relay station communicates with the terminal at the second frame resource. For example, if the second frame structure is a fifth configuration, and the second frame resource includes a zero^{th} subframe, a first subframe, a second subframe, a fourth subframe, a fifth subframe, a sixth subframe, and an eighth subframe, the relay station communicates with the terminal at the zero^{th} subframe, the first subframe, the second subframe, the fourth subframe, the fifth subframe, the sixth subframe, and the eighth subframe.

The selection criterion of the first frame resource and the second frame resource may include that, the zero^{th} subframe, the first subframe, the fifth subframe, and the sixth subframe are used for performance control over the terminal, that is, the frame resource for communication between the relay station and the terminal needs to include the above four subframes; therefore, the first frame resource cannot include the above four subframes, and the second subframe must include the above four subframes. After the first frame resource and the second frame resource are selected, at least one communication should be respectively completed between the base station and the relay station, and between the relay station and the terminal, that is, the first frame resource at least includes one uplink subframe, and one downlink subframe. The base station not only serves the relay station, but also serves the terminal that the base station directly serves, in order to avoid that mutual interference occurs between the communication of the base station and the terminal that the base station directly serves and the communication of the relay station and the terminal that the relay station directly serves, uplink-downlink configuration of subframe in the first frame structure other than the first frame resource is correspondingly the same as uplink-downlink configuration of the subframe in the second frame resource (the subframe in the first frame structure other than the first frame resource and the corresponding subframe in the second subframe resource correspondingly are both downlink subframes or both uplink subframes), or subframe in the first frame structure other than the first frame resource is a special subframe, and the corresponding subframe in the second frame structure is a downlink subframe. Specific configuration methods of the first frame structure, the second frame structure, the first frame resource, and the second frame resource may include the following solutions.

### Solution 1

FIG. 2 is a schematic structural view of a frame configuration according to an embodiment of the present invention. Referring to FIG. 2, a base station adopts a frame structure of a fourth configuration, and a relay station adopts a frame structure of a fifth configuration. The first frame resource includes a third subframe, a seventh subframe, and a ninth subframe; the second frame resource includes a zero^{th} subframe, a first subframe, a second subframe, a fourth subframe, a fifth subframe, a sixth subframe, and an eighth subframe, that is, a third subframe, a seventh subframe, and a ninth subframe in the second frame structure are blank subframes.

In the figure, D indicates downlink, U indicates uplink, and numeral after D or U indicate serial number of subframe for performing an HARQ feedback. For example, D2 under a subframe having a serial number of 0 means that if the subframe having the serial number of 0 is used to transmit data, a subframe having a serial number of 2 (when the value is less than the serial number of the current subframe, it shows that the subframe corresponding to the value in the next frame feeds back the HARQ at any moment) is required to perform the HARQ feedback. U8 under the subframe having the serial number of 2 means that if the subframe having the serial number of 2 is used to transmit data, a subframe having a serial number of 8 is required to perform the HARQ feedback. The second value under D or S indicates an uplink subframe number scheduled by the subframe, for example, G2 under the subframe having the serial number of 8 means that a serial number of the uplink subframe scheduled by the downlink subframe having the serial number of 8 is 2.

If the prior art is adopted, the relay station and the base station adopt the same configuration, that is, the relay station also adopts the frame structure having the configuration serial number of 4, if the relay station and the terminal adopt a subframe having a serial number of 6 or 8 to bear traffic data, a subframe having a serial number of 3 (a number after D is 3) is required to feed back the HARQ. At this time, the subframe having the serial number of 3 is a blank subframe, and is only used for communication between the base station and the relay station, and cannot be used for communication between the relay station and the terminal. Therefore, the subframe having the serial number of 6 or 8 cannot bear the traffic data, that is, at least two HARQ processes are affected in the prior art, and as the subframe having the serial number of 6 or 8 cannot bear the traffic data, resources are wasted.

In the embodiment of the present invention, the relay station adopts the configuration having the configuration serial number of 5, when the relay station and the terminal adopt the subframe having the serial number of 0, 1, 4, 5, 6, or 8 to bear traffic data, the subframe having the serial number of 2 is required to feed back the HARQ. The subframe having the serial number of 2 is not a blank subframe, that is, the subframe having the serial number of 2 is also used for communication between the relay station and the terminal. Therefore, under the above configuration condition, all the downlink subframes may be used for bearing the traffic data, and no HARQ process is affected. The performance is improved after the above configuration is adopted. In this embodiment, an uplink-downlink configuration ratio of the base station and the relay station is 1:2, which may be applied in a scene that the uplink and downlink require a proportion of 1:2.

FIG. 3 is a schematic structural view of an equivalent frame configuration according to an embodiment of the present invention. Referring to FIGS. 3 and 2, after the configuration of Solution 1 is adopted, corresponding numerals under the subframes having serial numbers of 6 and 8 for the fourth configuration are D2, at this time, the HARQ process is not affected. As for the current frame structure shown in Table 5, a purpose that a form of frame structure does not change, but an actual feedback relationship is changed is achieved. After the feedback relationship is changed, an effect on the HARQ may be avoided, the performance is improved, and the corresponding subframe may also bear the traffic data, thereby avoiding wasting resources.

### Solution 2

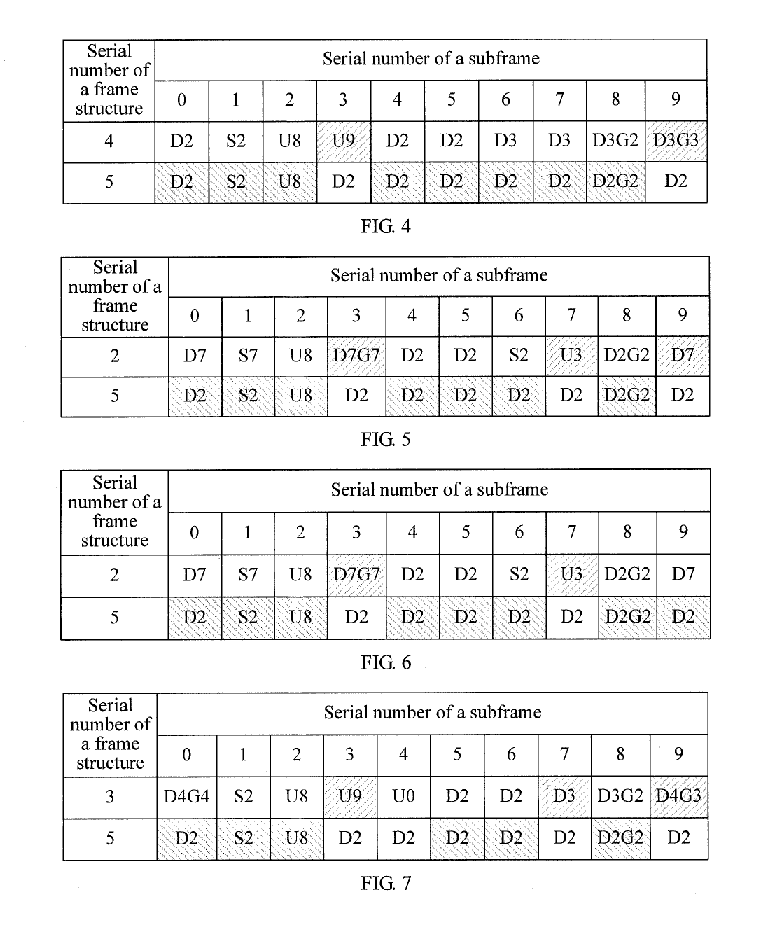

FIG. 4 is a schematic structural view of another frame configuration according to an embodiment of the present invention. A base station adopts a frame structure of a fourth configuration, and a relay station adopts a frame structure of a fifth configuration. The first frame resource includes a third subframe, and a ninth subframe; the second frame resource includes a zero^{th} subframe, a first subframe, a second subframe, a fourth subframe, a fifth subframe, a sixth subframe, a seventh subframe, and an eighth subframe, that is, a third subframe and a ninth subframe in the second frame structure are blank subframes.

Numerals and letters in FIG. 4 have the same meaning as those in FIG. 2, so the details will not be repeated herein again.

Similarly, the analysis method of Solution 1 is adopted, and if the prior art is adopted, at least two HARQ process are affected. In the embodiment of the present invention, as the relay station adopts the configuration having the configuration serial number of 5, when the relay station and the terminal adopt a subframe having a serial number of 0, 1, 4, 5, 6, 7, or 8, the subframe having a serial number of 2 is required to feed back the HARQ. The subframe having the serial number of 2 is not a blank subframe, that is, the subframe having the serial number of 2 is also used for communication between the relay station and the terminal. Therefore, under the above configuration condition, the downlink subframes may beused for bearing traffic data, and no HARQ process is affected. The performance is improved after the above configuration is adopted. In this embodiment, an uplink-downlink configuration ratio of the base station and the relay station is 1:1, which may be applied in a scene that the uplink and downlink require a proportion of 1:1.

### Solution 3

FIG. 5 is a schematic structural view of another frame configuration according to an embodiment of the present invention. A base station adopts a frame structure of a second configuration, and a relay station adopts a frame structure of a fifth configuration. The first frame resource includes a third subframe, a seventh subframe, and a ninth subframe; the second frame resource includes a zero^{th} subframe, a first subframe, a second subframe, a fourth subframe, a fifth subframe, a sixth subframe, and an eighth subframe, that is, a third subframe, a seventh subframe, and a ninth subframe in the second frame structure are blank subframes.

Numerals and letters in FIG. 5 have the same meaning as those in FIG. 2, so the details will not be repeated herein again.

If the prior art is adopted, the relay station and the base station adopt the same configuration, that is, the relay station also adopts the frame structure having the configuration serial number of 2, if the relay station and the terminal adopt the subframe having a serial number of 0 or 1 to bear the traffic data, a subframe having a serial number of 7 (a numeral after D is 7) is required to feed back an HARQ. At this time, the subframe having the serial number of 7 is a blank subframe, and is only used for communication between the base station and the relay station and cannot be used for communication between the relay station and the terminal. Therefore, the subframe having the serial number of 0 or 1 cannot bear the traffic data, that is, at least two HARQ processes are affected in the prior art, and as the subframe having the serial number of 0 or 1 cannot bear the traffic data, resources are wasted.

In the embodiment of the present invention, as the relay station adopts the configuration having the configuration serial number of 5, when the relay station and the terminal adopt a subframe having a serial number of 0, 1, 4, 5, 6, or 8 to bear the traffic data, a subframe having a serial number of 2 is required to feed back the HARQ. The subframe having the serial number of 2 is not the blank subframe, that is to say, the subframe having the serial number of 2 may also be used for communication between the relay station and the terminal. A subframe having a serial number of 6 in the configuration having the configuration serial number of 5 is a downlink subframe, in the configuration having a configuration serial number of 2, a subframe corresponding to this subframe is a special subframe; therefore, the downlink subframe affects an UpPTS part of the special subframe. A solvable manner is that in the downlink subframe, a part corresponding to the UpPTS part of the special subframe is blank, that is, only control information, synchronization information, or common reference signal are sent in the downlink subframe, namely, one HARQ process is affected. After the above configuration is adopted, one HARQ process is affected. Compared with the prior art in which at least two HARQ processes are affected, the performance is improved. In this embodiment, an uplink-downlink configuration ratio of the base station and the relay station is 1:2, which may be applied in a scene that the uplink and downlink require a proportion of 1:2.

### Solution 4

FIG. 6 is a schematic structural view of another frame configuration according to an embodiment of the present invention. A base station adopts a frame structure of a second configuration, and a relay station adopts a frame structure of a fifth configuration. The first frame resource includes a third subframe, and a seventh subframe; the second frame resource includes a zero^{th} subframe, a first subframe, a second subframe, a fourth subframe, a fifth subframe, a sixth subframe, an eighth subframe, and a ninth subframe, that is, a third subframe and a seventh subframe in the second frame structure are blank subframes.

Numerals and letters in FIG. 6 have the same meaning as those in FIG. 2, so the details will not be repeated herein again.

Similarly, the analysis method of Embodiment 3 is adopted, and if the prior art is adopted, at least two HARQ process are affected. In the embodiment of the present invention, the relay station adopts the configuration having the configuration serial number of 5, when the relay station and the terminal adopt a subframe having a serial number of 0, 1, 4, 5, 6, or 8 to bear traffic data, a subframe having a serial number of 2 is required to feed back an HARQ. The subframe having the serial number of 2 is not blank subframe, that is to say, the subframe having the serial number of 2 may also be used for communication between the relay station and the terminal, the HARQ is not affected. A subframe having a serial number of 6 in the configuration having the configuration serial number of 5 is a downlink subframe, in the configuration having a configuration serial number of 2, a subframe corresponding to this subframe is a special subframe; therefore, the downlink subframe affects an UpPTS part of the special subframe. A solvable manner is that in the downlink subframe, a part corresponding to the UpPTS part of the special subframe is blank, that is, only control information, synchronization information, or common reference signal are sent in the downlink subframe, namely, one HARQ process is affected. After the above configuration is adopted, one HARQ process is affected. Compared with the prior art in which at least two HARQ processes are affected, the performance is improved. In this embodiment, an uplink-downlink configuration ratio of the base station and the relay station is 1:2, which may be applied in a scene that the uplink and downlink require a proportion of 1:2.

### Solution 5

FIG. 7 is a schematic structural view of another frame configuration according to an embodiment of the present invention. A base station adopts a frame structure of a third configuration, and a relay station adopts a frame structure of a fifth configuration. The first frame resource includes a third subframe, a seventh subframe, and a ninth subframe; the second frame resource includes a zero^{th} subframe, a first subframe, a second subframe, a fifth subframe, a sixth subframe, and an eighth subframe, that is, a third subframe, a fourth subframe, a seventh subframe, and a ninth subframe in the second frame structure are blank subframes.

Numerals and letters in FIG. 7 have the same meaning as those in FIG. 2, so the details will not be repeated herein again.

If the prior art is adopted, the relay station and the base station adopt the same configuration, that is, when the relay station also adopts the frame structure having the configuration serial number of 3, if the relay station and the terminal adopt a subframe having a serial number of 8 to bear traffic data, a subframe having a serial number of 3 (a numeral after D is 3) is required to feed back an HARQ. At this time, the subframe having the serial number of 3 is a blank subframe, and is only used for communication between the base station and the relay station, and cannot be used for communication between the relay station and the terminal. Therefore, the subframe having the serial number of 8 cannot bear the traffic data. In the meantime, if the base station and the relay station adopt a subframe having a serial number of 9 to bear the traffic data, a subframe having a serial number of 4 (a numeral after D is 4) is required to feed back the HARQ. At this time, the subframe having the serial number of 4 is not a blank subframe, and is only used for communication between the relay station and the terminal, and cannot be used for communication between the base station and the relay station, therefore, the subframe having the serial number 9 cannot bear the traffic data. In the prior art, at least two processes are affected, and as the subframe having the serial number of 8 or 9 cannot bear the traffic data, resources are wasted.

In the embodiment of the present invention, as the relay station adopts the configuration having the configuration serial number of 5, when the relay station and the terminal adopt a subframe having a serial number of 0, 1, 2, 5, 6, or 8 to bear the traffic data, a subframe having a serial number of 2 is required to feed back the HARQ. The subframe having the serial number of 2 is not the blank subframe, that is to say, the subframe having the serial number of 2 may also be used for communication between the relay station and the terminal. The subframe having the serial number of 9 still cannot bear the traffic data, and in this embodiment, one HARQ process is affected. After the above configuration is adopted, one HARQ process is affected. Compared with the prior art in which at least two HARQ processes are affected, the performance is improved. In this embodiment, an uplink-downlink configuration ratio of the base station and the relay station is 1:2, which may be applied in a scene that the uplink and downlink require a proportion of 1:2.

### Solution 6

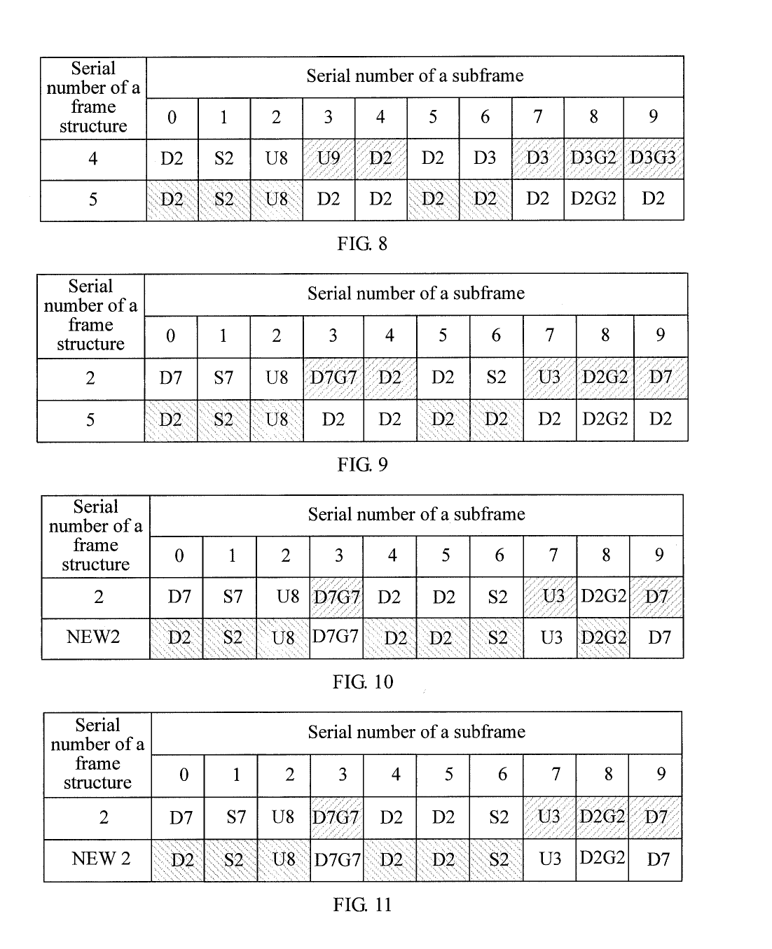

FIG. 8 is a schematic structural view of another frame configuration according to an embodiment of the present invention. A base station adopts a frame structure of a fourth configuration, and a relay station adopts a frame structure of a fifth configuration. The first frame resource includes a third subframe, and at least one of a fourth subframe, a seventh subframe, an eighth subframe, or a ninth subframe. Downlink subframes corresponding to the first frame resource in the fifth configuration are configured to be MBSFN subframes, and after the relay station receives data sent by the base station in the downlink subframes of the first frame resource, the relay station discards data corresponding to control parts of the MBSFN subframes. The second frame resource includes a zero^{th} subframe, a first subframe, a second subframe, a fifth subframe, and a sixth subframe, subframes in the fourth subframe, the seventh subframe, the eighth subframe, or the ninth subframe that are not included in the first frame resource, and the control parts of the MBSFN subframes.

Numerals and letters in FIG. 8 have the same meaning as those in FIG. 2, so the details will not be repeated herein again.

If the prior art is adopted, the relay station and the base station adopt the same configuration, that is, the relay station also adopts the frame structure having the configuration serial number of 4, if the relay station and the terminal adopt a subframe having a serial number of 6 to bear traffic data, a subframe having a serial number of 3 (a number after D is 3) is required to feed back an HARQ. The subframe having the serial number of 3 is only used for communication between the base station and the relay station, and cannot be used for communication between the relay station and the terminal. Therefore, the subframe having the serial number of 6 cannot bear the traffic data, that is, at least one HARQ process is affected in the prior art, and as the subframe having the serial number of 6 cannot bear the traffic data, resources are wasted. The MBSFN subframe is adopted, so that a scheduling and a feedback relationship for communication between the base station and the relay station may be redesigned, therefore, the HARQ process likely to be affected by the communication between the base station and the relay station is not considered in the above analysis. Similarly, in this embodiment and a next solution adopting the MBSFN subframe, a feedback relationship of the HARQ of communication between the base station and the relay station is not considered.

In the embodiment of the present invention, as the relay station adopts the configuration having the configuration serial number of 5, when the relay station and the terminal adopt a subframe having a serial number of 0, 1, 2, 5, 6 to bear the traffic data, a subframe having a serial number of 2 is required to feed back the HARQ. The subframe having the serial number of 2 may be used for communication between the relay station and the terminal, so a problem that the subframe having the serial number of 6 affects the HARQ process in the prior art does not occur. At the same time, the subframe having the serial number of 8 is the MBSFN subframe, and the subframe includes control and feedback information, therefore, the subframe having the serial number of 2 may used for communication between the relay station and the terminal. After the above configuration is adopted, no HARQ process is affected. Compared with the prior art in which at least one HARQ process is affected, the performance is improved.

### Solution 7

FIG. 9 is a schematic structural view of another frame configuration according to an embodiment of the present invention. A base station adopts a frame structure of a second configuration, and a relay station adopts a frame structure of a fifth configuration. The first frame resource includes a seventh subframe, and at least one of a third subframe, a fourth subframe, an eighth subframe, or a ninth subframe. Downlink subframes corresponding to the first frame resource in the fifth configuration are configured to be MBSFN subframes, and after the relay station receives data sent by the base station in the downlink subframes of the first frame resource, the relay station discards data corresponding to control parts of the MBSFN subframes. The second frame resource includes a zero^{th} subframe, a first subframe, a second subframe, a fifth subframe, and a sixth subframe, and subframes in the third subframe, the fourth subframe, the eighth subframe, or the ninth subframe that are not included in the first frame resource, and the control parts of the MBSFN subframes.

Numerals and letters in FIG. 9 have the same meaning as those in FIG. 2, so the details will not be repeated herein again.

If the prior art is adopted, the relay station and the base station adopt the same configuration, that is, the relay station also adopts the frame structure having the configuration serial number of 2, if the relay station and the terminal adopt the subframes having serial numbers of 0 and 1 to bear traffic data, a subframe having a serial number of 7 (a number after D is 7) is required to feed back an HARQ. At this time, the subframe having the serial number of 7 is only used for communication between the base station and the relay station, and cannot be used for communication between the relay station and the terminal. Therefore, the subframes having the serial numbers of 0 and 1 cannot bear the traffic data, that is, at least two processes are affected in the prior art, and as the subframe having the serial number of 0 or 1 cannot bear the traffic data, resources are wasted.

In the embodiment of the present invention, the relay station adopts the configuration having the configuration serial number of 5, so the relay station and the terminal need to adopt an uplink subframe having a serial number of 2 to feed back the HARQ. The subframe having the serial number of 2 may be used for communication between the relay station and the terminal, so a problem that the current subframe having the serial number of 0 or 1 causes an effect on the HARQ process does not occur. A subframe having a serial number of 6 in the configuration having the configuration serial number of 5 is a downlink subframe, in the configuration having a configuration serial number of 2, a subframe corresponding to this subframe is a special subframe; therefore, the downlink subframe affects an UpPTS part of the special subframe. A manner available for solving this problem is that in the downlink subframe, a part corresponding to the UpPTS part of the special subframe is blank, that is, only control information, synchronization information, or common reference signal are sent in the downlink subframe, namely, one HARQ process is affected. After the above configuration is adopted, one HARQ process is affected. Compared with the prior art in which at least two HARQ processes are affected, the performance is improved.

The following Solutions 8 to 12 further introduce the method of the embodiments of the present invention. In these solutions, the first frame structure adopted by the communication between the relay station and the base station may be any one frame structure of a zero^{th} configuration to a sixth configuration, an uplink-downlink configuration ratio of the second frame structure adopted by the communication between the relay station and the terminal served by the relay station is the same as that of the first frame structure, but a timing relationship of the second frame structure is different from the timing relationship of the first frame structure, for example, the timing relationship may be adjusted through the HARQ and/or GRANT. In the embodiment of the present invention, the base station may use the same method for sending the frame structure in an LTE TDD, that is, a 3-bit indication method is adopted to broadcast the frame structure. When the relay station broadcasts the frame structure, the 3-bit indication method may also be adopted. The 3-bit indication for broadcasting the frame structure used by the relay station and the base station may be the same or different. When the same 3 bits are sent, the relay station indicates an LTE-A terminal to select the first frame structure or the second frame structure according to the bits for configuring the MBSFN subframe. For example, a rightmost bit in the configuration bits of the MBSFN subframe in a System Information Block (SIB) 2 may be adopted to inform the LTE-A terminal to select the first frame structure or the second frame structure, so as to correspondingly enable the first frame structure or the second frame structure of the LTE TDD for communication.

### Solution 8

FIG. 10 is a schematic structural view of another frame configuration according to an embodiment of the present invention. A base station adopts a frame structure of a second configuration of an LTE TDD, and a relay station adopts a frame structure of a “NEW 2” configuration in the figure. A first frame resource includes a third subframe, a seventh subframe, and a ninth subframe. In the frame structure of the “NEW 2” configuration, the third subframe and the ninth subframe of downlink subframes are configured to be MBSFN subframes, after the relay station receives data sent by the base station in the downlink subframes of the first frame resource, the relay station discards data corresponding to control parts of the MBSFN subframes, or the relay station only receives corresponding data of other parts except the control parts of the MBSFN subframes in the downlink subframes of the first frame resource. The second frame resource includes a zero^{th} subframe, a first subframe, a second subframe, a fourth subframe, a fifth subframe, a sixth subframe, an eighth subframe, and the control parts of the MBSFN subframes.

Numerals and letters in FIG. 10 have the same meaning as those in FIG. 2, so the details will not be repeated herein again.

If the prior art is adopted, the relay station and the base station adopt the same configuration, that is, the relay station also adopts the frame structure having the configuration serial number of 2, if the relay station and the terminal adopt the subframes having serial numbers of 0 and 1 to bear traffic data, a subframe having a serial number of 7 (a number after D is 7) is required to feed back an HARQ. At this time, the subframe having the serial number of 7 is only used for communication between the base station and the relay station, and cannot be used for communication between the relay station and the terminal. Therefore, the subframes having the serial numbers of 0 and 1 cannot bear the traffic data, that is, at least two processes are affected in the prior art, and as the subframe having the serial number of 0 or 1 cannot bear the traffic data, resources are wasted.

In the embodiment of the present invention, as the relay station adopts the frame structure of the “NEW 2” configuration, the relay station and the terminal need to adopt an uplink subframe having a serial number of 2 to feed back the HARQ corresponding to subframes having serial numbers of 0 or 1. The subframe having the serial number of 2 can be used for communication between the relay station and the terminal, as long as the terminal can recognize the “NEW 2” frame structure, as for the terminal, a situation that the HARQ processes on subframes having serial numbers of 0 and 1 are affected does not exist, the subframes 0 and 1 can bear the traffic data for the terminal, and resources can be effectively used.

When this solution is applied and the relay station broadcasts the frame structure of the “NEW 2” configuration, the frame structure having the second configuration of the LTE TDD may be still broadcast for an LTE Release 8 (Rel-8) terminal, and the frame structure of the “NEW 2” configuration is separately and independently broadcast for the LTE-A terminal. At the same time, downlink scheduling is not given to the LTE Rel-8 terminal on the zero^{th} subframe and the first subframe, and the “not giving the downlink scheduling” means no PDSCH for the LTE Rel-8 terminal exists in the frame structure. Uplink scheduling is not given to the LTE Rel-8 terminal on the first subframe, and the “not giving the uplink scheduling” means that UL GRANT is not sent in the frame structure. Alternatively, when the relay station communicates with the terminal and the frame structure of the “NEW 2” configuration is broadcast, a 3-bit indication method for sending the frame structure of the second configuration in the LTE TDD system is adopted to broadcast the frame structure of the “NEW 2” configuration. The relay station indicates the LTE-A terminal to select the first frame structure or the second structure according to bits for configuring the MBSFN subframe. For example, a rightmost bit in bits for configuring the MBSFN subframe in an SIB 2 is adopted to inform the LTE-A terminal to select the frame structure of the second configuration or the frame structure of the “NEW 2” configuration, so as to correspondingly enable the frame structure of the second configuration of the LTE TDD or the frame structure having the “NEW 2” configuration for communication. In the meantime, the downlink scheduling is not given to the LTE Rel-8 terminal on the zero^{th} subframe and the first subframe, and the uplink scheduling is not given to the Rel-8 terminal on the first subframe.

### Solution 9

FIG. 11 is a schematic structural view of another frame configuration according to an embodiment of the present invention. A base station adopts a frame structure of a second configuration of an LTE TDD, and a relay station adopts a frame structure of a “NEW 2” configuration in the schematic view.

The first frame resource includes a third subframe, a seventh subframe, an eighth subframe, and a ninth subframe. Downlink subframes of a third subframe, an eighth subframe, and a ninth subframe in the frame structure of the “NEW 2” configuration are configured to be MBSFN subframes. After the relay station receives data sent by the base station in downlink subframes of a first frame resource, the relay station discards data corresponding to control parts of the MBSFN subframes. The second frame resource includes a zero^{th} subframe, a first subframe, a second subframe, a fourth subframe, a fifth subframe, and a sixth subframe, and the control parts of the MBSFN subframes.

Numerals and letters in FIG. 11 have the same meaning as those in FIG. 2, so the details will not be repeated herein again.

If the prior art is adopted, the relay station and the base station adopt the same configuration, that is, the relay station also adopts the frame structure having the configuration serial number of 2, if the relay station and the terminal adopt the subframes having serial numbers of 0 and 1 to bear traffic data, a subframe having a serial number of 7 (a number after D is 7) is required to feed back the HARQ. At this time, the subframe having the serial number of 7 is only used for communication between the base station and the relay station, and cannot be used for communication between the relay station and the terminal. Therefore, the subframes having the serial numbers of 0 and 1 cannot bear the traffic data, that is, at least two processes are affected in the prior art, and as the subframe having the serial number of 0 or 1 cannot bear the traffic data, resources are wasted.

In the embodiment of the present invention, as the relay station adopts the frame structure of the “NEW 2” configuration, the relay station and the terminal need to adopt an uplink subframe having a serial number of 2 to feed back an HARQ on subframes having serial numbers of 0 and 1. The subframe having the serial number of 2 may be used for communication between the relay station and the terminal, as long as the terminal can recognize the frame structure of the “NEW 2” configuration, as for the terminal, a situation that the HARQ processes of subframes having serial numbers of 0 and 1 are affected does not exist, the subframes 0 and 1 can bear the traffic data for the terminal, and resources can be effectively used.

When this solution is applied and the relay station broadcasts the frame structure of the “NEW 2” configuration, a frame structure of the second configuration of the LTE TDD may be still broadcast for an LTE Rel-8 terminal, the frame structure of the “NEW 2” configuration is separately and independently broadcast for the LTE-A terminal. In the meantime, downlink scheduling is not given to the LTE Rel-8 terminal on the zero^{th} subframe and the first subframe, and uplink scheduling is not given to the LTE Rel-8 terminal on the first subframe. Alternatively, when the relay station communicates with the terminal and the frame structure of the “NEW 2” configuration is broadcast, a 3-bit indication method for sending the frame structure of the second configuration in the LTE TDD system is adopted to broadcast the frame structure of the “NEW 2” configuration. The relay station indicates the LTE-A terminal to select the first frame structure or the second structure according to bits for configuring the MBSFN subframe. For example, a rightmost bit in bits for configuring the MBSFN subframe in an SIB 2 is adopted to inform the LTE-A terminal to select the frame structure of the second configuration or the frame structure of the “NEW 2” configuration, so as to correspondingly enable the frame structure of the second configuration of the LTE TDD or the frame structure of the “NEW 2” configuration for communication. In the meantime, the downlink scheduling is not given to the LTE Rel-8 terminal on the zero^{th} subframe and the first subframe, and the uplink scheduling is not given to the Rel-8 terminal on the first subframe. The judgment method may be that when the MBSFN subframe is informed, the MBSFN subframe is instructed to be configured to support Multimedia Broadcast Multicast Service (MBMS) service of the relay station or the real MBMS service, so that the LTE-A terminal judges whether the terminal itself is in a cell served by the relay station.

### Solution 10

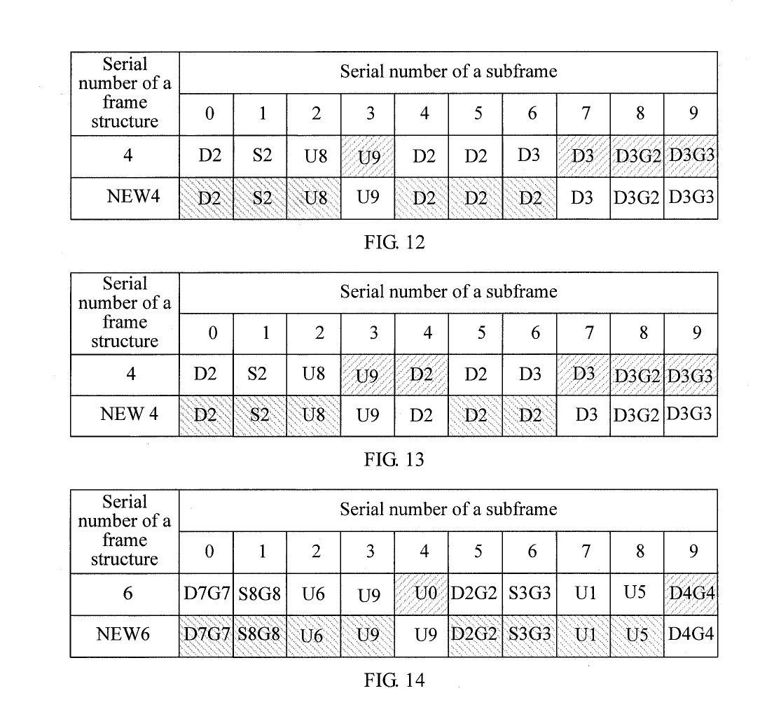

FIG. 12 is a schematic structural view of another frame configuration according to an embodiment of the present invention. A base station adopts a frame structure of a fourth configuration of an LTE TDD, and a relay station adopts a frame structure of a “NEW 4” configuration in the figure. The first frame resource includes a third subframe, a seventh subframe, an eighth subframe, and a ninth subframe. Downlink subframes of a seventh subframe, an eighth subframe, and a ninth subframe in the frame structure of the “NEW 4” configuration are configured to be MBSFN subframes. After the relay station receives data sent by the base station in downlink subframes of the first frame resource, the relay station discards data corresponding to control parts of the MBSFN subframes. The second frame resource includes a zero^{th} subframe, a first subframe, a second subframe, a fourth subframe, a fifth subframe, and a sixth subframe, and the control parts of the MBSFN subframes.

Numerals and letters in FIG. 12 have the same meaning as those in FIG. 2, so the details will not be repeated herein again.

If the prior art is adopted, the relay station and the base station adopt the same configuration, that is, the relay station also adopts the frame structure having the configuration serial number of 4, if the relay station and the terminal adopt a subframe having a serial number of 6 to bear traffic data, a subframe having a serial number of 3 (a number after D is 3) is required to feed back an HARQ. At this time, the subframe having the serial number of 3 is only used for communication between the base station and the relay station, and cannot be used for communication between the relay station and the terminal. Therefore, the subframe having the serial number of 6 cannot bear the traffic data, that is, at least one HARQ process is affected in the prior art, and as the subframe having the serial number of 6 cannot bear the traffic data, resources are wasted.

In the embodiment of the present invention, the relay station adopts the frame structure of the “NEW 4” configuration, the relay station and the terminal need to adopt an uplink subframe having a serial number of 2 to feed back the HARQ on a subframe having a serial number of 6. The subframe having the serial number of 2 may be used for communication between the relay station and the terminal, as long as the terminal can recognize the “NEW 4” frame structure, as for the terminal, a situation that the HARQ process of the subframe having the serial numbers of 6 is affected does not exist, the subframe 6 can bear the traffic data for the terminal, and resources can be effectively used.

When this embodiment is applied, the relay station broadcasts the frame structure of the “NEW 4” configuration, downlink scheduling is not given to a Rel-8 terminal on the sixth subframe, which may be the same as that the relay station broadcasts the frame structure of the fourth configuration of LTE TDD. After the LTE-A terminal receives the broadcast, it is firstly judged whether the LTE-A terminal is in a cell directly served by the base station or the cell served by the relay station, so as to correspondingly enable the frame structure of the fourth configuration of LTE TDD or the frame structure of the “NEW 4” configuration for communication. The judgment method may be that when the MBSFN subframe is informed, the MBSFN subframe is instructed to be configured to support MBMS service of the relay station or the real MBMS service, so that the LTE-A terminal judges whether the terminal is in a cell served by the relay station.

When this solution is applied, the relay station broadcasts the frame structure of the “NEW 4” configuration, the fourth configuration of LTE TDD is still broadcast for the Rel-8 terminal, and the “NEW 4” is separately and independently broadcast for the LTE-A terminal. In the meantime, downlink scheduling is not given to the LTE Rel-8 terminal on the sixth subframe; alternatively, when the relay station communicates with the terminal and the frame structure of the “NEW 4” is broadcast, the frame structure of the “NEW 4” configuration is broadcast by adopting a 3-bit indication method for sending the frame structure of the fourth configuration in the LTE TDD system. The relay station indicates the LTE-A terminal to select the first frame structure or the second structure according to the bits for configuring the MBSFN subframe. For example, a rightmost bit in bits for configuring the MBSFN subframe in an SIB 2 is adopted to inform the LTE-A terminal to select the frame structure of the fourth configuration or the frame structure of the “NEW 4” configuration, so as to correspondingly enable the frame structure of the fourth configuration of LTE TDD or the frame structure of the “NEW 4” configuration for communication. In the meantime, downlink scheduling is not given to the LTE Rel-8 terminal on the sixth subframe.

### Solution 11

FIG. 13 is a schematic structural view of another frame configuration according to an embodiment of the present invention. A base station adopts a frame structure of a fourth configuration of an LTE TDD, and a relay station adopts a frame structure of a “NEW 4” configuration in the schematic view. The first frame resource includes a third subframe, a fourth subframe, a seventh subframe, an eighth subframe, and a ninth subframe. Downlink subframes of a fourth subframe, a seventh subframe, an eighth subframe, and a ninth subframe in the frame structure having the “NEW 4” configuration are configured to be MBSFN subframes. After the relay station receives data sent by the base station in downlink subframes of a first frame resource, the relay station discards data corresponding to a control part of the MBSFN subframe. The second frame resource includes a zero^{th} subframe, a first subframe, a second subframe, a fifth subframe, and a sixth subframe, and the control parts of the MBSFN subframes.

Numerals and letters in FIG. 13 have the same meaning as those in FIG. 2, so the details will not be repeated herein again.

If the prior art is adopted, the relay station and the base station adopt the same configuration, that is, the relay station also adopts the frame structure having the configuration serial number of 4, if the relay station and the terminal adopt the subframe having a serial number of 6 to bear traffic data, a subframe having a serial number of 3 (a number after D is 3) is required to feed back an HARQ. At this time, the subframe having the serial number of 3 is only used for communication between the base station and the relay station, and cannot be used for communication between the relay station and the terminal. Therefore, the subframe having the serial number of 6 cannot bear the traffic data, that is, at least one HARQ process is affected in the prior art, and the subframe having the serial number of 6 cannot bear the traffic data, thereby, resources are wasted.

In the embodiment of the present invention, the relay station adopts the frame structure of the “NEW 4” configuration, the relay station and the terminal need to adopt an uplink subframe having a serial number of 2 to feed back the HARQ on a subframe having a serial number of 6. The subframe having the serial number of 2 may be used for communication between the relay station and the terminal, as long as the terminal can recognize the “NEW 4” frame structure, as for the terminal, a situation that the HARQ process of the subframe having the serial numbers of 6 is affected does not exist, the subframe 6 can bear the traffic data for the terminal, and resources can be effectively used.

When this solution is applied and the relay station broadcasts the frame structure of the “NEW 4” configuration, the frame structure of the fourth configuration of LTE TDD may be still broadcast for the Rel-8 terminal, and the frame structure of the “NEW 4” configuration may be separately and independently broadcast for the LTE-A terminal. In the meantime, downlink scheduling is not given to an LTE Rel-8 terminal on the sixth subframe; alternatively, when the relay station communicates with the terminal and the frame structure of the “NEW 4” is broadcast, the frame structure of the “NEW 4” configuration is broadcast by adopting a 3-bit indication method for sending the frame structure of the fourth configuration in the LTE TDD system. The relay station indicates the LTE-A terminal to select the first frame structure or the second structure according to the bits for configuring the MBSFN subframe. For example, a rightmost bit in bits for configuring the MBSFN subframe in an SIB 2 is adopted to inform the LTE-A terminal to select the frame structure of the fourth configuration or the frame structure of the “NEW 4” configuration, so as to correspondingly enable the frame structure of the fourth configuration of the LTE TDD or the frame structure of the “NEW 4” configuration for communication. In the meantime, downlink scheduling is not given to the LTE Rel-8 terminal on the sixth subframe.

### Solution 12

FIG. 14 is a schematic structural view of another frame configuration according to an embodiment of the present invention. A base station adopts a frame structure of a sixth configuration of an LTE TDD, and a relay station adopts a frame structure of a “NEW 6” in the schematic view.

The first frame resource includes a fourth subframe and a ninth subframe. A ninth subframe in the downlink subframes of the frame structure of the “NEW 6” configuration is configured to be an MBSFN subframe. After the relay station receives data sent by the base station in the downlink subframes of the first frame resource, the relay station discards data corresponding to a control part of the MBSFN subframe. The second frame resource includes a zero^{th} subframe, a first subframe, a second subframe, a third subframe, a fifth subframe, a sixth subframe, a seventh subframe, an eighth subframe, and the control part of the MBSFN subframe. The relay station indicates the LTE-A terminal to select the first frame structure or the second structure according to bits for configuring the MBSFN subframe. For example, a rightmost bit in bits for configuring the MBSFN subframe in an SIB 2 is adopted to inform the LTE-A terminal to select the frame structure of the sixth configuration or the frame structure of the “NEW 6” configuration.

Numerals and letters in FIG. 14 have the same meaning as those in FIG. 2, so the details will not be repeated herein again.

The above configurations are only examples, and other configuration solutions based on the above principle still fall within the protection scope of the present invention.

According to this embodiment, the base station and the relay station adopt different frame structures, a problem that the same frame structure affects greatly on the HARQ process is avoided, thereby improving the performance and increasing the utilization rate of resources.

Persons of ordinary skill in the art should understand that, all or a part of the steps of the method according to the embodiments may be implemented by a program instructing relevant hardware. The program may be stored in a computer readable storage medium. When the program is executed, the steps of the method according to the embodiments are performed. The storage medium may be any medium capable of storing program codes, such as a ROM, a RAM, a magnetic disk, or an optical disk.

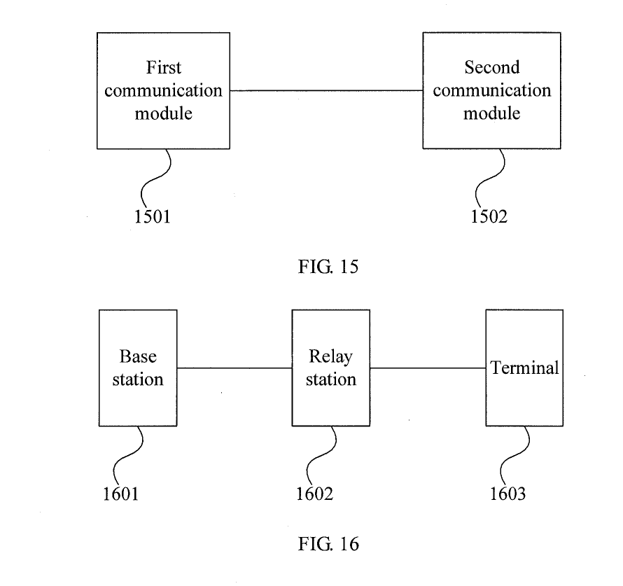

FIG. 15 is a schematic structural view of a relay station according to an embodiment of the present invention, and the relay station includes a first communication module 1501 and a second communication module 1502. The first communication module 1501 is configured to communicate with a base station by using a first frame resource in a first frame structure. The second communicating module 1502 is configured to communicate with a terminal served by the relay station by using a second frame resource in a second frame structure different from the first frame structure.

Furthermore, uplink-downlink configuration of a subframe in the second frame resource adopted in the second communication module 1502, is correspondingly the same as uplink-downlink configuration of a subframe other than the subframes in the first frame resource in the first frame structure; or a sixth subframe in the second frame resource is a downlink subframe, a sixth subframe in the first frame structure corresponding to this sixth frame in the second frame resource is a special subframe; other than the subframes in the first frame resource and a sixth subframe, uplink-downlink configuration of a subframe in the second frame resource is correspondingly the same as a subframe in the first frame structure.

A reference of specific selection solutions of the first frame structure, the second frame structure, the first frame resource, and the second frame resource may be made to the solutions in the method embodiments.

According to this embodiment, the relay station adopts a different frame structure with the base station for communication, a problem that the same frame structure affects greatly on the HARQ process is avoided, thereby improving the performance and increasing the utilization rate of resources.

FIG. 16 is a schematic structural view of a communication system according to an embodiment of the present invention. The communication system includes a base station 1601, a relay station 1602, and a terminal 1603. The base station 1601 is configured to communicate with the relay station 1602 by adopting a first frame resource of a first frame structure. The relay station 1602 is configured to communicate with the terminal 1603 served by the relay station by adopting a second frame resource in a second frame structure different from the first frame structure. The terminal 1603 is configured to communicate with the relay station 1602 by using the second frame resource.

Furthermore, uplink-downlink configuration of a subframe in the second frame resource adopted by the relay station 1602, is correspondingly the same as uplink-downlink configuration of a subframe other than the subframes in the first frame resource in the first frame structure; or a sixth subframe in the second frame resource adopted by the relay station 1602 is a downlink subframe, a sixth subframe in the first frame structure corresponding to this sixth frame in the second frame resource is a special subframe; other than the subframes in the first frame resource and a sixth subframe, uplink-downlink configuration of a subframe in the second frame resource is correspondingly the same as uplink-downlink configuration of a subframe in the first frame structure. A reference of specific selection solutions of the first frame structure, the second frame structure, the first frame resource, and the second frame resource may be made to the solutions in the method embodiments.

According to this embodiment, the relay station adopts a different frame structure with the base station to communicate, a problem that the same frame structure affects greatly on the HARQ process is avoided, thereby improving the performance and increasing the utilization rate of resources.

The method, device, and system may be applied in systems such as the LTE, the LTE-A, the WiMax, and the UMB.

Finally, it should be noted that the above embodiments are merely provided for describing the technical solutions of the present invention, but not intended to limit the present invention. It should be understood by persons of ordinary skill in the art that although the present invention has been described in detail with reference to the preferred embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the present invention.

What is claimed is:

1. A communication method, comprising:
communicating with a base station by adopting a first frame resource in a first frame structure; and
communicating with a terminal served by a relay station by adopting a second frame resource, wherein the second frame resource is included in a second frame structure different from the first frame structure.

2. The method according to claim 1, wherein
uplink-downlink configuration of a subframe in the second frame resource is correspondingly the same as uplink-downlink configuration of a subframe other than the subframes in the first frame resource in the first frame structure; or
a sixth subframe in the second frame resource is a downlink subframe, a sixth subframe in the first frame structure corresponding to this sixth frame in the second frame resource is a special subframe; other than the subframes in the first frame resource and the sixth subframe in the first frame structure, uplink-downlink configuration of a subframe in the second frame resource is correspondingly the same as uplink-downlink configuration of a subframe in the first frame structure.

3. The method according to claim 1, wherein when the first frame structure is a frame structure of a fourth configuration, and the second frame structure is a frame structure of a fifth configuration,
the first frame resource comprises a third subframe, a seventh subframe, and a ninth subframe, the second frame resource comprises a zero^{th} subframe, a first subframe, a second subframe, a fourth subframe, a fifth subframe, a sixth subframe, and an eighth subframe, and subframes other than the second frame resource are configured to be blank subframes; or
the first frame resource comprises a third subframe and a ninth subframe, the second frame resource comprises a zero^{th} subframe, a first subframe, a second subframe, a fourth subframe, a fifth subframe, a sixth subframe, a seventh subframe, and an eighth subframe, and subframes other than the second frame resource are configured to be blank subframes.

4. The method according to claim 1, wherein when the first frame structure is a frame structure of a second configuration, and the second frame structure is a frame structure of a fifth configuration,
the first frame resource comprises a third subframe, a seventh subframe, and a ninth subframe, the second frame resource comprises a zero^{th} subframe, a first subframe, a second subframe, a fourth subframe, a fifth subframe, a sixth subframe, and an eighth subframe, and subframes other than the second frame resource are configured to be blank subframes; or
the first frame resource comprises a third subframe and a seventh subframe, the second frame resource comprises a zero^{th} subframe, a first subframe, a second subframe, a fourth subframe, a fifth subframe, a sixth subframe, an eighth subframe, and an ninth subframe, and subframes other than the second frame resource are configured to be blank subframes.

5. The method according to claim 1, wherein when the first frame structure is a frame structure of a third configuration, and the second frame structure is a frame structure of a fifth configuration, the first frame resource comprises a third subframe, a seventh subframe, and a ninth subframe, the second frame resource comprises a zero^{th} subframe, a first subframe, a second subframe, a fifth subframe, a sixth subframe, and an eighth subframe, and subframes other the second frame resource are configured to be blank subframes.

6. The method according to claim 1, wherein when the first frame structure is a frame structure of a fourth configuration, and the second frame structure is a frame structure of a fifth configuration, the first frame resource comprises a third subframe, and at least one of a fourth subframe, a seventh subframe, an eighth subframe, and a ninth subframe, downlink subframes corresponding to the first frame resource in the second frame structure are configured to be Multicast Broadcast Single Frequency Network (MBSFN) subframes, and the second frame resource comprises a zero^{th} subframe, a first subframe, a second subframe, a fifth subframe, a sixth subframe, subframes in the fourth subframe, the seventh subframe, the eighth subframe, and the ninth subframe that are not comprised in the first frame resource, and control parts of the MBSFN subframes.

7. The method according to claim 1, wherein when the first frame structure is a frame structure of a second configuration, and the second frame structure is a frame structure of a fifth configuration, the first frame resource comprises a seventh subframe, and at least one of a third subframe, a fourth subframe, an eighth subframe, and a ninth subframe, downlink subframes corresponding to the first frame resource in the second frame structure are configured to be MBSFN subframes, and the second frame resource comprises a zero^{th} subframe, a first subframe, a second subframe, a fifth subframe, a sixth subframe, subframes in the third subframe, the fourth subframe, the eighth subframe, and the ninth subframe that are not comprised in the first frame resource, and control parts of the MBSFN subframes.

8. The method according to claim 1, wherein the first frame structure is a frame structure of any configuration of a zero^{th} configuration to a sixth configuration, an uplink-downlink configuration of the second frame structure is the same as an uplink-downlink configuration of the first frame structure, and a timing relationship of the second frame structure is different from a timing relationship of the first frame structure.

9. The method according to claim 1, wherein the communicating with the terminal served by the relay station comprises:
broadcasting the second frame structure for a Long Term Evolution (LTE) Advanced (LTE-A) system terminal, and broadcasting the first frame structure for an LTE system release 8 Rel-8 terminal; or
broadcasting the second frame structure by using the same 3-bit indication method for sending a frame structure in an LTE Time Division Duplex (TDD) system.

10. The method according to claim 8, wherein the communicating with the terminal served by the relay station comprises:
broadcasting the second frame structure for a LTE-A system terminal, and broadcasting the first frame structure for an LTE system Rel-8 terminal; or
broadcasting the second frame structure by using the same 3-bit indication method for sending a frame structure in an LTE Time Division Duplex (TDD) system.

11. The method according to claim 9, wherein if the second frame structure is broadcast by using the same 3-bit indication method for sending the frame structure in the LTE TDD system, the method further comprises:
indicating a LTE-A terminal to select the first frame structure or the second frame structure according to a rightmost bit in bits for configuring an MBSFN) subframe in a System Information Block (SIB) 2.

12. The method according to claim 9, wherein the first frame structure is a frame structure of a second configuration, or a frame structure of a fourth configuration, or a frame structure of a sixth configuration.

13. The method according to claim 12, wherein when the first frame structure is the frame structure of the second configuration,
the first frame resource comprises a third subframe, a seventh subframe, and a ninth subframe, a third subframe and a ninth subframe of downlink subframes in the second frame structure are configured to be MBSFN subframe, and the second frame resource comprises a zero^{th} subframe, a first subframe, a second subframe, a fourth subframe, a fifth subframe, a sixth subframe, an eighth subframe, and control parts of the MBSFN subframes; or
the first frame resource comprises a third subframe, a seventh subframe, an eighth subframe, and a ninth subframe; a third subframe, an eighth subframe, and a ninth subframe of downlink subframes in the second frame structure are configured to be MBSFN subframes, and the second frame resource comprises a zero^{th} subframe, a first subframe, a second subframe, a fourth subframe, a fifth subframe, a sixth subframe, and control parts of the MBSFN subframes.

14. The method according to claim 12, wherein when the first frame structure is the frame structure of the fourth configuration,
the first frame resource comprises a third subframe, a seventh subframe, an eighth subframe, and a ninth subframe; a seventh subframe, an eighth subframe, and a ninth subframe of downlink subframes in the second frame structure are configured to be MBSFN subframes, and the second frame resource comprises a zero^{th} subframe, a first subframe, a second subframe, a fourth subframe, a fifth subframe, a sixth subframe, and control parts of the MBSFN subframes; or
the first frame resource comprises a third subframe, a fourth subframe, a seventh subframe, an eighth subframe, and a ninth subframe; a fourth subframe, a seventh subframe, an eighth subframe, and a ninth subframe of downlink subframes in the second frame structure are configured to be MBSFN subframes, and the second frame resource comprises a zero^{th} subframe, a first subframe, a second subframe, a fifth subframe, a sixth subframe, and control parts of the MBSFN subframes.

15. The method according to claim 12, wherein when the first frame structure is the frame structure of the sixth configuration,
the first frame resource comprises a fourth subframe and a ninth subframe; a ninth subframe of downlink subframes in the second frame structure is configured to be an MBSFN subframe, and the second frame resource comprises a zero^{th} subframe, a first subframe, a second subframe, a third subframe, a fifth subframe, a sixth subframe, a seventh subframe, an eighth subframe, and a control part of the MBSFN subframe.

16. A relay station, comprising:
a first communication module, configured to communicate with a base station by adopting a first frame resource in a first frame structure; and
a second communication module, configured to communicate with a terminal served by a relay station by adopting a second frame resource, wherein the second frame resource is included in a second frame structure different from the first frame structure.

17. The relay station according to claim 16, wherein
uplink-downlink configuration of a subframe in the second frame resource is correspondingly the same as uplink-downlink configuration of a subframe other than the subframes in the first frame resource in the first frame structure; or
a sixth subframe in the second frame resource is a downlink subframe, a sixth subframe in the first frame structure corresponding to this sixth frame in the second frame resource is a special subframe; other than the subframes in the first frame resource and a sixth subframe, uplink-downlink configuration of a subframe in the second frame resource is correspondingly the same as uplink-downlink configuration of a subframe in the first frame structure.

18. The relay station according to claim 16, wherein the first frame structure adopted by the first communication module is a frame structure of any configuration of a zero^{th} configuration to a sixth configuration; and
an uplink-downlink configuration of the second frame structure adopted by the second communication module is the same as an uplink-downlink configuration of the first frame structure, and a timing relationship of the second frame structure is different from a timing relationship of the first frame structure.

19. A communication system, comprising:
a relay station, configured to communicate with a base station by adopting a first frame resource in a first frame structure, and communicate with a terminal served by the relay station by using a second frame resource, wherein the second frame resource is included in a second frame structure different from the first frame structure.

20. The system according to claim 19, wherein
uplink-downlink configurations of subframes in the second frame resource adopted by the relay station other than subframes corresponding to the first frame resource of the first frame structure are correspondingly the same; or
a sixth subframe in the second frame resource adopted by the relay station is a downlink subframe, a sixth subframe in the first frame structure corresponding to the sixth subframe is a special subframe, and uplink-downlink configurations of subframes in the second frame resource other than the sixth subframe and the first frame resource corresponding to the first frame structure are correspondingly the same.
